(19) United States
(12) Patent Application Publication
(10) Pub. No.: US 2010/0006465 A1
(43) Pub. Date: Jan. 14, 2010

(54) BLISTER PACK WITH FOLDED WINGS

(76) Inventor: Joseph Nazari, Glendale, CA (US)

Correspondence Address: YING CHEN;Chen Yoshimura LLP, 255 S. GRAND AVE., # 215, LOS ANGELES, CA, 90012, US

(21) Appl. No.: 12/171,818

(22) Filed: Jul. 11, 2008

(51) Int. Cl. B65D 73/00; B31B 3/00; B31B 1/74

(52) U.S. Cl. 206/461; 493/162; 493/148

(57) ABSTRACT

A blister pack for packaging a product is disclosed. The blister pack has a backing structure including a main section and a wing section joined to the main section and disposed at an angle with respect to the main section. The main section includes two stacked backing sheets adhered together, at lease one backing sheet defining at lest one cutout area. The product is housed in a container, which includes a chamber section where the product is housed and a flat insertion portion. The insertion portion is held between the two backing sheets of the main section and the chamber portion protrudes from the cutout area. The blister pack can be made by folding a continuous sheet of backing material.

### BACKGROUND OF THE INVENTION

1. Field of the Invention

This invention relates to product packaging, and in particular, it relates to a blister pack having folded wings.

2. Description of the Related Art

A type of product package, common called a blister pack or a sandwich pack, shown in FIGS. 6(a)-(b), includes two stacked backing sheets 101, 102 (made of corrugated cardboards, chipboards, sheets of paper, etc.) having one or more cutout areas, and one or more plastic containers 103, 103′ each having a flat insertion portion 103a trapped between the two backing sheets and a chamber portion 103b protruding from the cutout areas of the backing sheets for housing a product. The two backing sheets 101, 102 are adhered together by an adhesive 104. The backing sheets are typically flat; the two backing sheets may be made of one sheet folded over.

### SUMMARY OF THE INVENTION

The present invention is directed to a d blister pack having a backing structure with one or more wing sections.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a blister pack for packaging a product, which includes: a backing structure including a main section and a wing section joined to the main section and disposed at an angle with respect to the main section, wherein the main section includes two stacked backing sheets adhered together, at least one backing sheet defining at least one cutout area; and a container having a flat insertion portion disposed between the two backing sheets of the main section of the backing structure and a chamber section protruding from the cutout area of the backing sheet for housing the product.

In another aspect, the present invention provides a method of making a blister pack for a product, which includes the steps of: providing a sheet of back material, the sheet of back material defining at least one cutout area; providing a container, the container having a flat insertion portion and a chamber portion for housing the product; placing the container against the backing material with the chamber portion protruding from the cutout area; folding the backing material continuously into a backing structure, the backing structure including a main section and a wing section joined to the main section and disposed at an angle with respect to the main section, the main section including two portions of the backing material against each other holding the insertion portion of the container in between; and adhering the two portions of the backing material together with an adhesive.

It is to be understood that both the foregoing general description and the following detailed description are exemplary and explanatory and are intended to provide further explanation of the invention as claimed.

### BRIEF DESCRIPTION OF THE DRAWINGS

FIGS. 1(a)-(c) illustrate a blister pack according to an embodiment of the present invention.

FIG. 2 shows the blister pack in a half-closed state to illustrate the folding of the backing material.

FIG. 3 shows a sheet of backing material before it is folded into the backing structure.

FIGS. 4(a)-5(c) illustrate blister packs according to alternative embodiments of the present invention.

FIG. 6(a)-(b) illustrate a conventional blister pack.

### DETAILED DESCRIPTION OF THE PREFERRED EMBODIMENTS

The improved blister pack has a three-dimensional backing structure made of folded corrugated cardboards, chipboards, sheets of paper, etc.

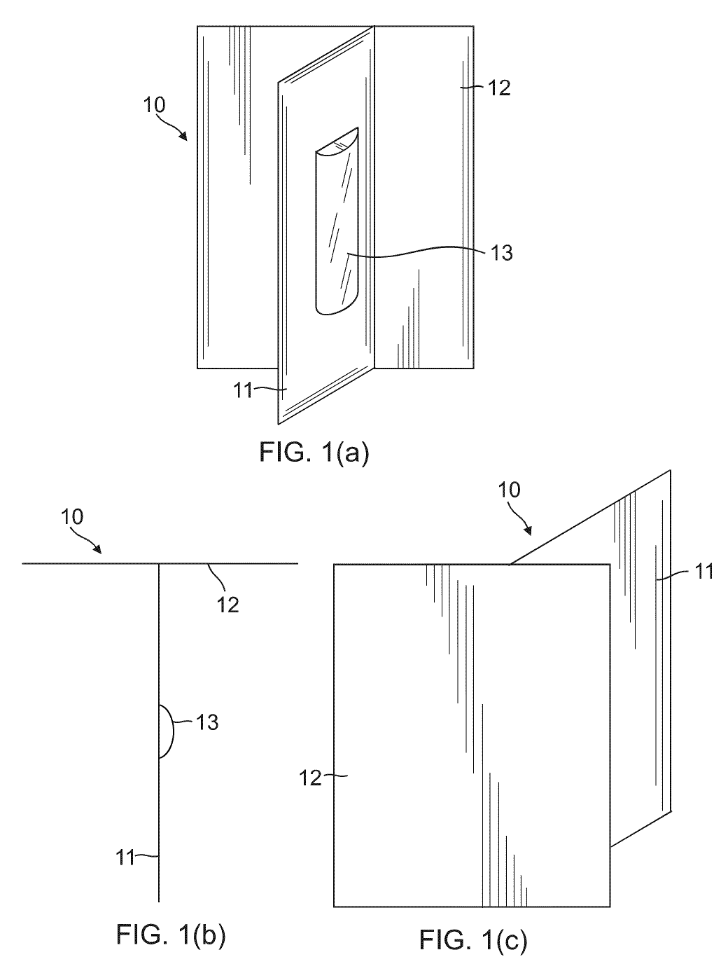

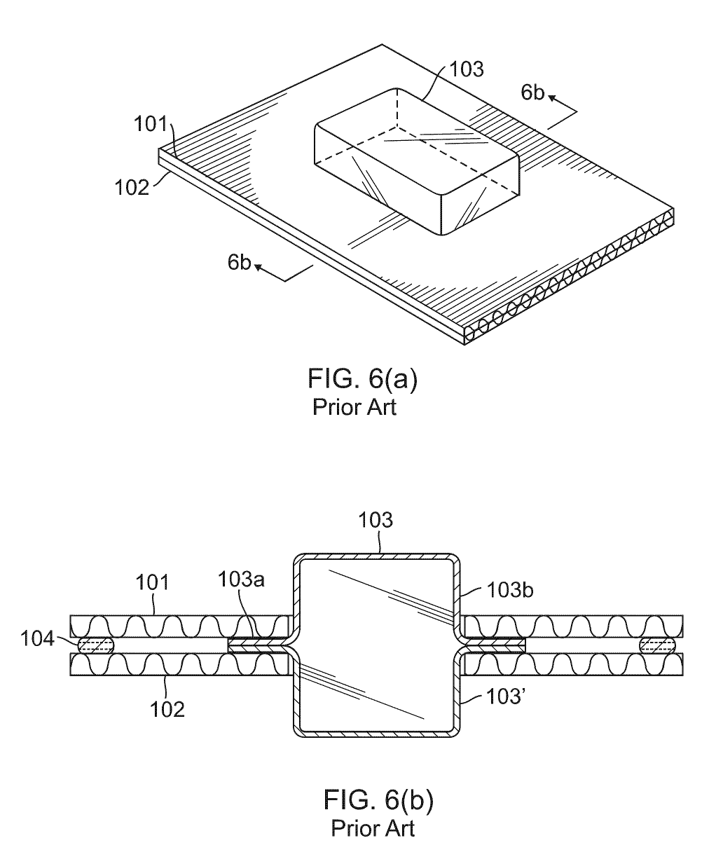

FIGS. 1(a)-(c) illustrate a blister pack according to an embodiment of the present invention. FIG. 1(a) is a front perspective view, FIG. 1(b) is a top plan view, and FIG. 1(c) is a rear perspective view. The blister pack 10 includes has a backing structure formed of a suitable material such as corrugated cardboards, chipboards, sheets of paper, etc., which has a main section 11 and a wing section 12 joined to the main section 11 and disposed substantially perpendicular to the main section. The main section 11 is formed of two (or more) backing sheets; the wing section is formed of one or two (or more) backing sheets. A container 13, preferably made of a clear plastic material, is mounted on the main section 11. As in a conventional blister pack, the plastic container 13 has a flat section portion trapped between the two backing sheets of the main section 11 (not shown in FIGS. 1(a)-(c), but see FIG. 6(b)) and a chamber portion protruding from a cutout are of the backing sheet for housing a product.

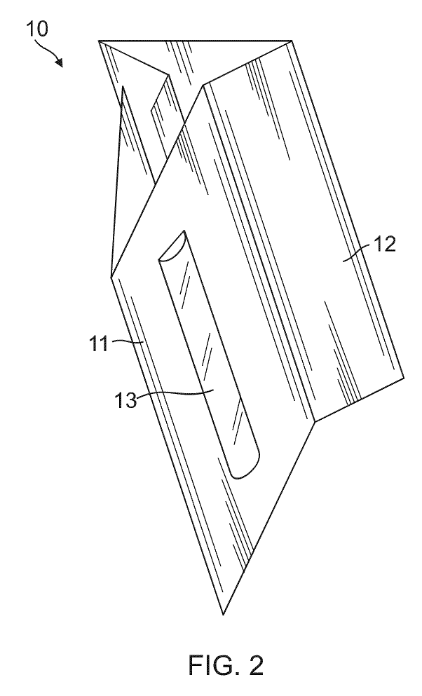

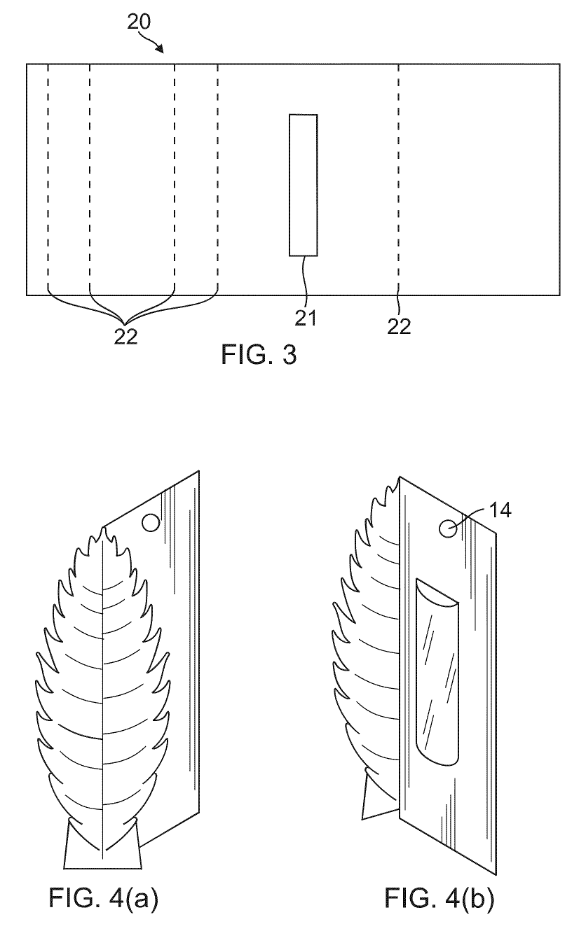

In a preferred embodiment, the blister pack 10 is formed by folding one continuous sheet of backing material. FIG. 2 shows the blister pack in a half-closed state to illustrate the folding of the backing material, and FIG. 3 illustrates a sheet of the backing material 20 before it is folded into the backing structure. FIG. 3 also shows a cutout area 21 from which the plastic container 13 will protrude in the finished package. Preferably, a number of fold lines (scores, perforations, etc.) 22 are pre-formed into the backing material 20 to facilitate folding and forming of the pack. The dimensions shown in FIG. 3 are merely exemplary. Of course, other ways of folding the sheet into the backing structure can be employed.

The container 13 is placed before the pack is completely closed. The folded backing material is then adhered together on the inside to form the finished pack. The adhesive may be applied to the inner surface of the backing material 20 before or after folding. In a preferred embodiment, the inner surface of the backing material 20 is pre-coated with a heat sensitive or pressure sensitive adhesive. After folding, the main section and the wing section are pressed, and the adhesive is activated by heat (if a heated press is used) or pressure during the pressing step to adhere the backing material together.

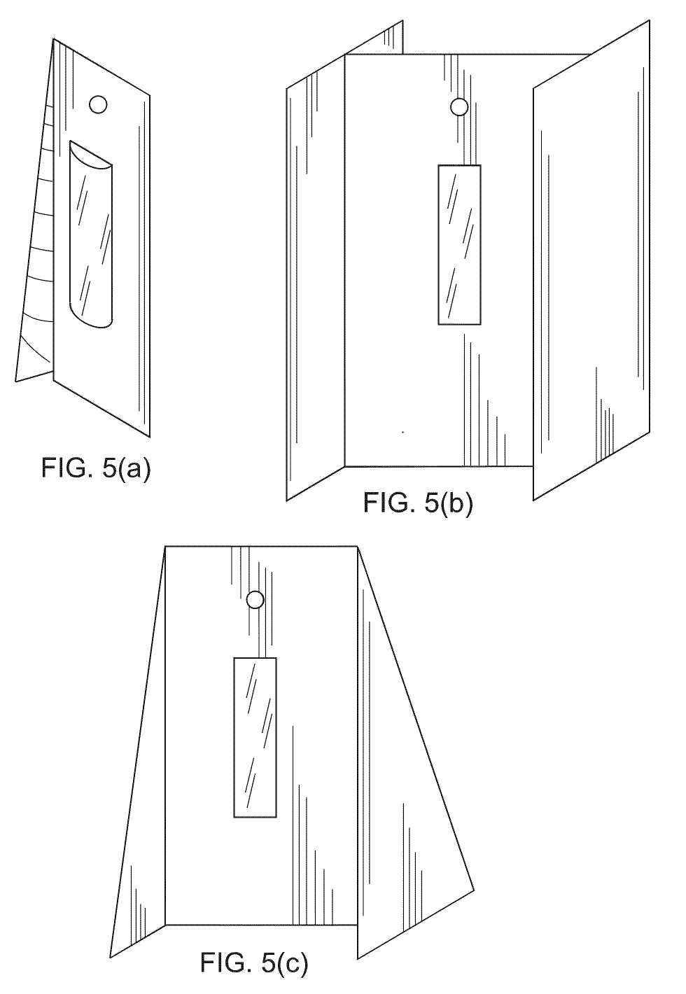

FIGS. 4(a)-5(c) illustrate a number of alternative blister packs with folded wings according to embodiments of the present invention. FIGS. 4(a)-(b) are two perspective views of a blister pack where the wing section has a decorative shape. FIG. 5(a) shows a blister pack having a triangular shaped wing section. FIGS. 5(b)-(c) show two blister packs with two wings formed on each end of the main section. These packs can be formed from pre-cut backing materials in a similar manner as described above. The wing sections of the blister pack may have any desirable shape. FIGS. 4(a)-5(c) also shows that the pack can be optionally provided with a hole 14 in the backing structure for convenient hanging.

As in a conventional blister pack, the backing sheet(s) may be printed, or an additional printed sheet may cover all or a part of the backing structure.

Although in the illustrated embodiments the wing section(s) and the main section of the backing structure are substantially perpendicular to each other, they may form a non-right angle. In addition, two parts of the wing section may form an angle with respect to each other to form a Y shape together with the main section. Any other suitable shapes may be used.

The blister pack with wings according to embodiments of the present invention has several advantages. Such a pack can be free standing for convenient display. It has a three-dimensional shape (as opposed to a flat, essentially two-dimensional shape of conventional blister packs), which makes the package shopable from three sides—when it is displayed in the free-standing manner, customers can shop it from the front, from left side and right side, while the conventional blister pack is shopable only from the front. The three-dimensional shape also creates more space for placing graphics to describe the product. The wings also increase the rigidity of the package, whereas conventional blister packs can be folded more easily. This also makes it more tamper resistant and theft resistant.

It will be apparent to those skilled in the art that various modification and variations can be made in the improved blister pack of the present invention without departing from the spirit or scope of the invention. Thus, it is intended that the present invention cover modifications and variations that come within the scope of the appended claims and their equivalents.

What is claimed is:

1. A blister pack for packaging a product, comprising:
a backing structure including a main section and a wing section joined to the main section and disposed at an angle with respect to the main section, wherein the main section includes two stacked backing sheets adhered together, at least one backing sheet defining at least one cutout area; and
a container having a flat insertion portion disposed between the two backing sheets of the main section of the backing structure and a chamber section protruding from the cutout area of the backing sheet for housing the product.

2. The blister pack of claim 1, wherein the backing structure is formed from one continuous sheet of backing material folded over.

3. The blister pack of claim 2, wherein the backing material is corrugated cardboard, chipboard, or paper.

4. The blister pack of claim 1, wherein the container is made of a clear plastic material.

5. The blister pack of claim 1, wherein the wing section is perpendicular to the main section.

6. A method of making a blister pack for a product, comprising:
providing a sheet of back material, the sheet of back material defining at least one cutout area;
providing a container, the container having a flat insertion portion and a chamber portion for housing the product;
placing the container against the backing material with the chamber portion protruding from the cutout area;
folding the backing material continuously into a backing structure, the backing structure including a main section and a wing section joined to the main section and disposed at an angle with respect to the main section, the main section including two portions of the backing material against each other holding the insertion portion of the container in between; and
adhering the two portions of the backing material together with an adhesive.

7. The method of claim 6, further comprising:
coating an inner surface of the backing material with the adhesive; and
pressing the two portions of the backing material in the main section to adhere them together.

8. The method of claim 6, wherein the backing material is corrugated cardboard, chipboard, or paper.

9. The method of claim 6, wherein the container is made of a clear plastic material.

10. The method of claim 6, wherein the wing section is perpendicular to the main section.
